(19) United States
(12) Patent Application Publication
(10) Pub. No.: US 2016/0168410 A1
(43) Pub. Date: Jun. 16, 2016

(54) FILMS, FLUOROPOLYMER COATED FILMS AND HIGHLY CLEANABLE ARTICLES

(71) Applicant: E I DU PONT DE NEMOURS AND COMPANY, Wilmington, DE (US)

(72) Inventors: MICHAEL JOSEPH BROWN, WILMINGTON, DE (US); EDWIN JAMES LIGHTFOOT, AMHERST, NY (US); DONALD DOUGLAS MAY, CHADDS FORD, PA (US); MOOKKAN PERIYASAMY, WILMINGTON, DE (US); RONALD EARL USCHOLD, WEST CHESTER, PA (US)

(21) Appl. No.: 14/969,480

(22) Filed: Dec. 15, 2015

Related U.S. Application Data
(60) Provisional application No. 62/092,518, filed on Dec. 16, 2014.

(51) Int. Cl. C09D 127/16; C09D 127/18; C09D 127/20; C09D 127/14

(52) U.S. Cl. CPC C09D 127/16; C09D 127/14; C09D 127/18; C09D 127/20; C08J 2327/14

(57) ABSTRACT

In a first aspect, a film includes a fluoropolymer. The fluoropolymer includes a blend of polyvinyl fluoride and a fluoroadditive. The fluoroadditive includes a fluoropolymer having pendant trifluoromethyl groups. In a second aspect, a fluoropolymer coated film includes a polymeric substrate film and a fluoropolymer coating on the polymeric substrate film. The fluoropolymer coating includes a blend of polyvinyl fluoride and a fluoroadditive. The fluoroadditive includes a fluoropolymer having pendant trifluoromethyl groups. In a third aspect, a highly cleanable article includes a fluoropolymer. The fluoropolymer includes a blend of polyvinyl fluoride and a fluoroadditive. The fluoroadditive includes a fluoropolymer having pendant trifluoromethyl groups.

### BACKGROUND INFORMATION

1. Field of the Disclosure

This disclosure is in the field of films, fluoropolymer coated films and highly cleanable articles.

2. Description of the Related Art

Films comprised of fluoropolymers are commonly used in applications where it is desirable to take advantage of the low surface energy of the fluoropolymer to limit the sticking of dirt or to allow for easier cleaning of the surface. For example, films of ethylene-tetrafloroethytlene copolymer (ETFE) or tetrafluoroethylene-hexafluoropropylene copolymer (FEP) can be used in signage and building applications where it is important to maintain a clean attractive appearance, and where it may be necessary to clean unwanted markings (e.g., graffiti) from surfaces. It is particularly desirable to have surfaces which are easily cleaned without the use of organic solvents, and especially desirable to have surfaces that can be cleaned without any liquid at all.

For example, dry erase marking boards are well-known articles that can be marked with dry wipe markers, also known as dry erase markers or dry erasable markers, and then wiped clean without the use of liquid cleaners. However, the ability of the marking surface to releasably retain a marking composition can degrade over time resulting in “ghosting”, wherein traces of the marking composition are retained on the surface after erasing. In some cases, ghost marks can be removed by using liquid cleaners, but as the surface of the marking board further degrades, even these liquid cleaners may be unsuccessful in removing the ghost marks. Furthermore, in some instances dry erase marking boards are inadvertently marked with permanent markers that are designed to fixedly adhere to articles and surfaces and can result in permanent marks that cannot be removed from the surface of a dry erase marking board without severely degrading the release properties of the surface.

Fluorinated small molecules (such as DuPont™ Capstone® fluorosurfactants) have been used as additives to reduce the surface energy of various films and coatings, but small molecules can migrate in a polymer matrix and can be removed from the surface, such that, over time, the surface energy of such films or coatings can increase. Fluoroadditives that are more permanently anchored in the polymer matrix would be better suited to maintaining low surface energy, improving the long-term cleanability of articles.

Polyvinyl fluoride (PVF) has been manufactured for many years and has found many uses as a film or coating over a variety of substrates. For example, PVF has been incorporated into backsheets for photovoltaic modules, where it provides superior weatherability, mechanical, electrical and barrier properties. PVF homopolymer is not soluble in conventional solvents, however, so films or coatings of PVF are typically made from dispersions of PVF in latent solvents, from which a film or coating is coalesced. Films of PVF are generally not used in applications that require cleanability because the surface can degrade over time such that ghosting becomes prevalent.

### SUMMARY

In a first aspect, a film includes a fluoropolymer. The fluoropolymer includes a blend of polyvinyl fluoride and a fluoroadditive. The fluoroadditive includes a fluoropolymer having pendant trifluoromethyl groups.

In a second aspect, a fluoropolymer coated film includes a polymeric substrate film and a fluoropolymer coating on the polymeric substrate film. The fluoropolymer coating includes a blend of polyvinyl fluoride and a fluoroadditive. The fluoroadditive includes a fluoropolymer having pendant trifluoromethyl groups.

In a third aspect, a highly cleanable article includes a fluoropolymer. The fluoropolymer includes a blend of polyvinyl fluoride and a fluoroadditive. The fluoroadditive includes a fluoropolymer having pendant trifluoromethyl groups.

The foregoing general description and the following detailed description are exemplary and explanatory only and are not restrictive of the invention, as defined in the appended claims.

### DETAILED DESCRIPTION

In a first aspect, a film includes a fluoropolymer. The fluoropolymer includes a blend of polyvinyl fluoride and a fluoroadditive. The fluoroadditive includes a fluoropolymer having pendant trifluoromethyl groups.

In one embodiment of the first aspect, the fluoropolymer having pendant trifluoromethyl groups includes a vinyl fluoride interpolymer, a tetrafluoroethylene-hexafluoropropylene copolymer, a perfluoro vinyl ether, a perfluoroalkyl ethylene, a perfluoroalkoxy polymer, a fluoroelastomer, or a mixture thereof. In a specific embodiment, the fluoropolymer having pendant trifluoromethyl groups includes a vinyl fluoride interpolymer. In a more specific embodiment, the vinyl fluoride interpolymer includes an interpolymer consisting essentially of units derived from vinyl fluoride and at least two highly fluorinated monomers. In a still more specific embodiment, at least one of the highly fluorinated monomers introduces into the polymer a side chain of at least one carbon atom.

In another more specific embodiment, the vinyl fluoride interpolymer includes an interpolymer consisting essentially of units derived from about 20 to about 60 mol % vinyl fluoride, from about 10 to about 60 mol % of at least one C₂ olefin selected from the group consisting of vinylidene fluoride, tetrafluoroethylene, trifluoroethylene, and chlorotrifluoroethylene, and from about 1 to about 20 mol % of a highly fluorinated monomer which introduces into the polymer a side chain of at least one carbon atom. In a still more specific embodiment, the highly fluorinated monomer which introduces into the polymer a side chain of at least one carbon atom is selected from the group consisting of hexafluoropropylene, 1,1-dihydrotetrafluoropropylene, 1,2-dihydrotetrafluoropropylene, perflourobutyl ethylene, and mixtures thereof. In another still more specific embodiment, the interpolymer consists essentially of vinyl fluoride, tetrafluoroethylene and hexafluoropropylene.

In another embodiment of the first aspect, the fluoropolymer includes from about 0.5 to about 35 weight percent of fluoroadditive based on total weight solids. In a specific embodiment, the fluoropolymer includes from about 1.25 to about 20 weight percent of fluoroadditive based on total weight solids.

In yet another embodiment of the first aspect, the fluoropolymer has an advancing water contact angle of at least about 90 degrees.

In still another embodiment of the first aspect, the fluoropolymer has a receding water contact angle of at least about 60 degrees.

In still yet another embodiment of the first aspect, the fluoropolymer has an advancing hexadecane contact angle of at least about 25 degrees.

In a further embodiment of the first aspect, the fluoropolymer has a receding hexadecane contact angle of at least about 15 degrees.

In a second aspect, a fluoropolymer coated film includes a polymeric substrate film and a fluoropolymer coating on the polymeric substrate film. The fluoropolymer coating includes a blend of polyvinyl fluoride and a fluoroadditive. The fluoroadditive includes a fluoropolymer having pendant trifluoromethyl groups.

In one embodiment of the second aspect, the fluoropolymer coated film further includes a primer, an adhesive, or both a primer and an adhesive.

In a third aspect, a highly cleanable article includes a fluoropolymer. The fluoropolymer includes a blend of polyvinyl fluoride and a fluoroadditive. The fluoroadditive includes a fluoropolymer having pendant trifluoromethyl groups.

In one embodiment of the third aspect, the highly cleanable article can be cleaned without the use of an organic solvent.

In another embodiment of the third aspect, an image made using a permanent marker can be removed from the highly cleanable article without the use of organic solvents or other liquids.

### DEFINITIONS

The following definitions are used herein to further define and describe the disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

As used herein, the terms “a” and “an” include the concepts of “at least one” and “one or more than one”.

Unless stated otherwise, all percentages, parts, ratios, etc., are by weight.

When the term “about” is used in describing a value or an end-point of a range, the disclosure should be understood to include the specific value or end-point referred to.

Many aspects and embodiments have been described above and are merely exemplary and not limiting. After reading this specification, skilled artisans appreciate that other aspects and embodiments are possible without departing from the scope of the invention. Other features and advantages of the invention will be apparent from the following detailed description, and from the claims.

### Vinyl Fluoride Fluoropolymers

Fluoropolymers useful in accordance with one aspect of the invention are selected from homopolymers and copolymers of vinyl fluoride (VF). In one embodiment, homopolymers and copolymers of vinyl fluoride comprise at least 60 mole % vinyl fluoride. In a more specific embodiment, homopolymers and copolymers of vinyl fluoride comprise at least 80 mole % vinyl fluoride. Blends of VF with non-fluoropolymers, e.g., acrylic polymers, may also be suitable for the practice of some aspects of the invention. Homopolymer PVF coatings can be formed from a high molecular weight polyvinyl fluoride (PVF). Homopolymer PVF is well suited for the practice of specific aspects of the invention.

In one embodiment, with VF copolymers, comonomers can be either fluorinated or non-fluorinated or combinations thereof. By the term “copolymers” is meant copolymers of VF with any number of additional fluorinated or non-fluorinated monomer units so as to form dipolymers, terpolymers, tetrapolymers, etc. If non-fluorinated monomers are used, the amount used should be limited so that the copolymer retains the desirable properties of the fluoropolymer, e.g., cleanability. In one embodiment, fluorinated comonomers are used including fluoroolefins, fluorinated vinyl ethers, or fluorinated dioxoles. Examples of useful fluorinated comonomers include tetrafluoroethylene (TFE), hexafluoropropylene (HFP), chlorotrifluoroethylene (CTFE), trifluoroethylene, hexafluoroisobutylene, perfluorobutyl ethylene (PFBE), perfluoro (propyl vinyl ether) (PPVE), perfluoro (ethyl vinyl ether) (PEVE), perfluoro (methyl vinyl ether) (PMVE), perfluoro-2,2-dimethyl-1,3-dioxole (PDD) and perfluoro-2-methylene-4-methyl-1,3-dioxolane (PMD) among many others. Suitable VF copolymers are taught by U.S. Pat. Nos. 6,242,547 and 6,403,740 to Uschold.

### Fluoroadditives

As used herein, the term “fluoroadditive” refers to a compound containing fluorine atoms that is used as a minority component in blends with other materials. Even in small quantities, a fluoroadditive can impart properties of fluorine-containing compounds, such as enhanced abrasion resistance, reduced coefficient of friction and mechanical wear, reduced surface contamination and other beneficial mechanical, electrical and barrier properties that are characteristic of fluorine-containing compounds.

In one embodiment, a fluoroadditive can be a fluoropolymer including one or more fluoromonomers having pendant trifluoromethyl (—CF₃) groups, such as a vinyl fluoride interpolymer, a tetrafluoroethylene-hexafluoropropylene copolymer (FEP), a perfluoro vinyl ether, a perfluoroalkyl ethylene (e.g., perfluorobutyl ethylene), a perfluoroalkoxy polymer (PFA), a fluoroelastomer (e.g., a hexafluoropropylene-vinylidene fluoride copolymer), or a mixture thereof. In one embodiment, the fluoropolymer for the fluoroadditive can include from about 0.1 to about 100 mol % fluoromonomer(s) having pendant —CF₃ groups, or from about 1 to about 100 mol %, or from about 5 to about 100 mol % fluoromonomer(s) having pendant —CF₃ groups.

In one embodiment, a vinyl fluoride interpolymer includes an interpolymer consisting essentially of units derived from vinyl fluoride and at least two highly fluorinated monomers. In a specific embodiment, at least one of the highly fluorinated monomers introduces into the polymer a side chain of at least one carbon atom. For the purposes of the present invention, “consists essentially of” means that, while the interpolymer may contain other monomer units, the significant properties of the interpolymer are determined by the named monomer units. In one embodiment, an interpolymer composition comprises from about 20 to about 60 mol % vinyl fluoride; from about 10 to about 60 mol % of at least one C₂ olefin selected from the group consisting of vinylidene fluoride, tetrafluoroethylene, trifluoroethylene, and chlorotrifluoroethylene; and from about 1 to about 20 mol % of at least one highly fluorinated monomer which introduces into the polymer a side chain of at least one carbon atom. In another embodiment, an interpolymer comprises from about 25 to about 45 mol % vinyl fluoride, from about 40 to about 60 mol % of the C₂ olefin and from about 1.5 to about 15 mol % of the highly fluorinated monomer. In one embodiment, highly fluorinated monomers, which introduce into the polymer a side chain of at least one carbon atom, include perfluoroolefins having 3 to 10 carbon atoms, highly fluorinated olefins such as CF₃CY═CY₂ where Y is independently H or F, perfluoroC₁-C₈alkyl ethylenes, fluorinated dioxoles, and fluorinated vinyl ethers of the formula CY₂═CYOR or CY₂═CYOR′OR wherein Y is H or F, and R and —R′ are independently completely-fluorinated or partially-fluorinated alkyl or alkylene group containing 1 to 8 carbon atoms, and in some embodiments are perfluorinated. In one embodiment, R groups contain 1 to 4 carbon atoms, and in some embodiments are perfluorinated. In one embodiment, R′ groups contain 2 to 4 carbon atoms, and in some embodiments are perfluorinated. In one embodiment, Y is F. For the purposes of the present disclosure, highly fluorinated is intended to mean that 50% or greater of the atoms bonded to carbon are fluorine, excluding linking atoms such as O or S.

In some embodiments, highly fluorinated monomers are perfluoroolefins, such as hexafluoropropylene (HFP); partially hydrogenated propenes such as 2,3,3,3-tetrafluoropropene and 1,3,3,3-tetrafluoropropene; partially hydrogenated propylenes such as 1,1-dihydrotetrafluoropropylene, 1,2-dihydrotetrafluoropropylene; perfluoroC₁-C₈alkyl ethylenes, such as perfluorobutyl ethylene (PFBE); or perfluoro(C₁-C₈alkyl vinyl ethers), such as perfluoro(ethyl vinyl ether) (PEVE). Fluorinated dioxole monomers include perfluoro-2,2-dimethyl-1,3-dioxole (PDD) and perfluoro-2-methylene-4-methyl-1,3-dioxolane (PMD). Hexafluoroisobutylene is another highly fluorinated monomer useful in some embodiments. In a specific embodiment, the interpolymer consists essentially of vinyl fluoride, tetrafluoroethylene and hexafluoropropylene.

In one embodiment, a fluoropolymer comprises from about 0.5 to about 35 weight percent of fluoroadditive based on total weight solids. In one embodiment, a fluoropolymer comprises from about 1.25 to about 20 weight percent of fluoroadditive based on total weight solids.

### Fluoropolymer Films

Blending a fluoroadditive that includes a fluoropolymer with pendant —CF₃ groups with PVF may result in a fluoropolymer film with lower surface energy, improving its anti-soiling properties and making it easier to clean. In one embodiment, such fluoropolymer films may be cleaned without the use of organic solvents. In a specific embodiment, they may be cleaned without the use of any liquid at all (i.e., dry erased).

In one embodiment, fluoropolymer films including a blend of PVF and a fluoroadditive can be made using a solvent extrusion or casting process. For example, U.S. Pat. No. 2,953,818 discloses an extrusion process for the preparation of orientable films from PVF and U.S. Pat. No. 3,139,470 discloses a process for preparing oriented PVF films. The term “oriented”, as used herein, refers to an orientation process, under which a polymeric film or sheet is uni-axially or bi-axially stretched in transverse and/or machine directions to achieve a combination of mechanical and physical properties. Stretching apparatus and processes to obtain uni-axially or bi-axially oriented films or sheets are known in the art and may be adapted by those skilled in the art to produce the films or sheets disclosed herein. Examples of such apparatus and processes include, for example, those disclosed in U.S. Pat. Nos. 3,278,663; 3,337,665; 3,456,044; 4,590,106; 4,760,116; 4,769,421; 4,797,235; and 4,886,634. In such processes, the fluoropolymer film is solvent extruded or cast onto a polymeric web from which it can be removed after drying to form a freestanding film.

Typical dispersions for PVF are prepared using solvents which have boiling points high enough to avoid bubble formation during the film forming/drying process and which aid in coalescence of the PVF. The polymer concentration in these dispersions is adjusted to achieve a workable viscosity of the dispersion and will vary with the particular polymer, the other components of the coating composition, and the process equipment and conditions used. In one embodiment, the fluoropolymer is present in an amount of about 25 wt % to about 50 wt % based on the total weight of the liquid fluoropolymer coating composition. The nature and preparation of PVF dispersions are described in detail in U.S. Pat. Nos. 2,419,008; 2,510,783; and 2,599,300. In a specific embodiment, dispersions are formed in propylene carbonate (PC), γ-butyrolactone (GBL), N-methylpyrrolidone (NMP), dimethyl acetamide (DMAC) or dimethylsulfoxide (DMSO). In addition, these dispersions may contain co-solvents, such as glycol ethers (e.g., butyl CELLOSOLVE™), butoxy ethyl acetate (BEA) or propylene glycol methyl ether acetate (PMA) or others to facilitate the coating process.

In one embodiment, fluoropolymer films including a blend of PVF and a fluoroadditive can be made by solvent casting. In one embodiment, solvent casting can include coating a liquid fluoropolymer coating composition onto a polymeric web, coalescing or curing the coating composition to form fluoropolymer film, drying to remove the solvent and then removing the fluoropolymer film from the polymeric web. In another embodiment fluoropolymer films including a blend of PVF and a fluoroadditive can be produced by melt extrusion. In yet another embodiment, fluoropolymer films can be made by solvent assisted extrusion as described in U.S. Pat. No. 3,139,470.

In one embodiment, fluoropolymer films including a blend of PVF and a fluoroadditive can be made by coating a liquid fluoropolymer coating composition onto a polymeric substrate film to form a fluoropolymer coated film. In one embodiment, a primer, an adhesive, or both a primer and an adhesive may be used to improve the adhesion of the fluoropolymer coating to the polymeric substrate to be coated. In another embodiment, fluoropolymer coatings may be applied directly to unprimed polymeric substrates without the use of an adhesive. In one embodiment, a liquid fluoropolymer coating compositions may contain PVF and fluoroadditive in the form of a dispersion. To prepare the liquid fluoropolymer coating composition in dispersion form, the PVF may be milled in a suitable solvent. If the fluoroadditive is used in dispersion form, it may be milled separately or along with the PVF. The milled fluoropolymer(s) may then be combined with any other component used in the liquid fluoropolymer coating composition.

### Applications

Films, fluoropolymer coated films and articles including a blend of PVF and a fluoroadditive are useful in a variety of applications where surfaces with reduced surface energy are desirable. These applications include signage, dry-erasable white boards, building applications, wall coverings, interior and exterior surfaces of transportation vehicles, and any other applications where it is desirable to have a readily cleanable surface. As used herein, the terms “highly cleanable” and “high cleanability” refer to an article or surface from which an image made using permanent markers can be releasably retained with minimal ghosting. In one embodiment, an image made using a permanent marker (such as a Sharpie® permanent marker, available from Sanford L.P., Oak Brook, Ill.) can be releasably retained on a cleanable article or surface with minimal ghosting. In one embodiment, an image made using a permanent marker can be removed from a cleanable article or surface without the use of organic solvents or other liquids. Those skilled in the art will appreciate the wide variety of applications that may benefit from these films, fluoropolymer coated films and articles.

In one embodiment, films including a blend of PVF and a fluoroadditive may have sufficiently low surface energy to be used in dry-erasable white board applications. Such useful films may have an advancing water contact angle of at least about 90 degrees, or at least about 100 degrees, or a receding water contact angle of at least about 60 degrees, or at least about 70 degrees, or an advancing hexadecane contact angle of at least about 25 degrees, or at least about 35 degrees, or a receding hexadecane contact angle of at least about 15 degrees, or at least about 25 degrees.

### Test Methods

### Contact Angles

Advancing and receding contact angles were measure for both water and hexadecane using a Ramé-Hart contact angle goniometer (Ramé-Hart Instrument Company, Sucasunna, N.J.). The liquid was delivered with a syringe, and for advancing and receding angles the liquid droplet was slowly expanded or retracted, respectively. The syringe needle remained in the droplet while the measurements were obtained as is generally recommended.

### EXAMPLES

The concepts described herein will be further described in the following examples, which do not limit the scope of the invention described in the claims.

### Examples 1 to 5 and Comparative Examples 1 to 7

A 45 wt % PVF in propylene carbonate base dispersion was used to prepare Examples 1 to 5 (E1-E5) and Comparative Example 1 (CE1).

For CE1, the PVF base dispersion was mixed in a high speed mixer, drawn down using a doctor blade onto a PET film and dried in a 428° F. (220° C.) oven for two minutes.

Comparative Examples 2-4 (CE2-CE4) include commercial films of PVF (CE2, Tedlar® PVF film TUT10AG3, a clear oriented film from E.I du Pont de Nemours & Co., Wilmington, Del.), FEP (CE3, Teflon® FEP 200 Fluoroplastic Film, DuPont), and ETFE (CE4, Tefzel® ETFE 200 LZ Fluoroplastic Film, DuPont).

For Example 1 (E1), 5 wt % (solids basis) of a perfluorobutyl ethylene (PFBE) interpolymer (a terpolymer of 58 wt % tetrafluoroethylene, 35 wt % vinyl fluoride and 7 wt % perflourobutyl ethylene) was added to the PVF base dispersion and a film was made following the procedure of CE1. The same was done for Examples 2 to 4 (E2-E4), except that in place of the PFBE interpolymer, a VF interpolymer (E2, 65 wt % TFE, 20 wt % VF and 15 wt % HFP), FEP (E3, Teflon® FEP 9495 resin in powder form, DuPont), and a fluoroelastomer (E4, Viton® A-100, DuPont) were used. While the PFBE interpolymer, the VF interpolymer and the fluoroelastomer decreased the surface energy compared to the PVF film without fluoroadditive (CE1), as evidenced by an increase in the advancing and receding contact angles for both water and hexadecane (as shown in Table 1), the FEP fluoroadditive (E3) did not show any significant change in contact angles.

Example 5 (E5) repeated E3 with the same FEP, but used a reverse gravure coating process to make the film, instead of drawing down using a doctor blade, resulting in a film that had reduced surface energy. E5 demonstrates that by adjusting the processing conditions, the surface properties can be improved. For instance, differences in coating techniques, drying conditions and residence times may result in differences between the surface composition compared to that of the bulk. Those skilled in the art will appreciate that surface properties can be optimized by using different processing conditions to produce articles and films of PVF with fluoroadditives.

For Comparative Examples 5-7 (CE5-CE7), the procedure of E1 was followed, except that fluoroadditives that do not have pendant trifluoromethyl groups were used; ETFE (CE5), polyvinylidene fluoride (PVDF, CE6) and ethylene chlorotrifluoroethylene (ECTFE, CE7). These three fluoroadditive do not show any clear improvement over the PVF film without fluoroadditive (CE1). Table 1 summarized the results for E1-E5 and CE1-CE7.

TABLE 1

| | | wt % | Adv. | Rec. | Adv. | Rec. |
|---|---|---|---|---|---|---|
| Example | Fluoroadditive | (solids) | Water | Water | Hexadec. | Hexadec. |
| CE1 | none | — | 76 | 61 | 8 | 0 |
| CE2 | none | — | 67 | 26 | 0 | 0 |
| CE3 | none | — | 119 | 99 | 53 | 45 |
| CE4 | none | — | 99 | 80 | 39 | 24 |
| E1 | PFBE | 5 | 102 | 79 | 48 | 32 |
| | interpolymer | | | | | |
| E2 | VF interpolymer | 5 | 99 | 69 | 39 | 23 |
| E3 | FEP | 5 | 71 | 59 | 9 | 0 |
| E4 | Viton ® | 5 | 104 | 62 | 46 | 31 |
| E5 | FEP gravure | 5 | 99 | 74 | 40 | 30 |
| CE5 | ETFE | 5 | 75 | 60 | 21 | 0 |
| CE6 | PVDF | 5 | 80 | 61 | 11 | 0 |
| CE7 | ECTFE | 5 | 79 | 60 | 11 | 0 |

Examples 1 to 5 demonstrate that using a blend of PVF and fluoroadditives that have pendant trifluoromethyl groups can decrease the surface energy of fluoropolymer coated films.

To examine cleanability, films were marked with red, blue and black Sharpie® permanent markers (Sanford), stored overnight under ambient conditions and then scrubbed vigorously for 30 seconds with a dry cloth (Sontara® SPS wipes, DuPont). The films were visually inspected and an estimate of the percentage of marking composition removed was made for each color of permanent marker (Table 3). In the case of CE3 (FEP film), the surface did not releasably retain the marking compositions. Instead, the marking compositions formed wet puddles on the CE3 film surface, so the cleanability of CE3 was not further evaluated.

TABLE 2

| | | wt % | | | |
|---|---|---|---|---|---|
| Example | Fluoroadditive | (solids) | Red | Blue | Black. |
| CE1 | none | — | 80 | 70 | 90 |
| CE2 | none | — | 0 | 0 | 0 |
| CE3 | none | — | — | — | — |
| CE4 | none | — | 50 | 90 | 100 |
| E1 | PFBE interpolymer | 5 | 100 | 40 | 80 |
| E2 | VF interpolymer | 5 | 100 | 100 | 100 |
| E3 | FEP | 5 | 80 | 90 | 100 |
| E5 | FEP gravure | 5 | 100 | 100 | 100 |
| CE5 | ETFE | 5 | 50 | 50 | 50 |
| CE6 | PVDF | 5 | 50 | 50 | 50 |
| CE7 | ECTFE | 5 | 50 | 50 | 50 |

While none of the marking compositions could be completely removed from PVF films without fluoroadditive (CE1 and CE2), the films of PVF with fluoroadditives that have pendant trifluoromethyl groups (E1-E3 and E5) showed very good to excellent cleanability with all three colors of permanent marker. The overall cleanability of PVF films with fluoroadditives that do not have pendant trifluoromethyl groups (CE5-CE7) was inferior.

### Examples 6 to 11

For Examples 6 to 11 (E6-E11), fluoroadditives that have pendant trifluoromethyl groups were blended with PVF at lower (2.5 wt %) and higher (10 wt %) levels following the procedure of E1. In addition, fluoroadditives were added to the PVF dispersion as either powders (E6, E9-E10), dispersions (E7-E8) or solutions (E11). The reduced surface energy effect remains when using the VF interpolymer, but for other fluoroadditives, there does appear to be a lower limit at which little change in surface energy is seen. Those skilled in the art will appreciate that when changing the composition of the fluoropolymer film, modifications to the process used to form the film may be needed to optimize the surface properties of the final film. Table 3 summarizes results for E6-E11.

TABLE 3

| | | wt % | Adv. | Rec. | Adv. | Rec. |
|---|---|---|---|---|---|---|
| Example | Fluoroadditive | (solids) | Water | Water | Hexadec. | Hexadec. |
| CE1 | none | — | 76 | 61 | 8 | 0 |
| E6 | FEP powder | 2.5 | 73 | 61 | 7 | 0 |
| E7 | FEP dispersion | 2.5 | 67 | 51 | 9 | 0 |
| E8 | PFA dispersion | 2.5 | 64 | 48 | 8 | 0 |
| E9 | VF interpolymer | 2.5 | 96 | 74 | 40 | 27 |
| E10 | VF interpolymer | 10 | 101 | 74 | 42 | 27 |
| E11 | Viton ® | 10 | 105 | 63 | 46 | 30 |

Note that not all of the activities described above in the general description or the examples are required, that a portion of a specific activity may not be required, and one or more further activities may be performed in addition to those described. Still further, the order in which activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that one or more modifications or one or more other changes can be made without departing from the scope of the invention as set forth in the claims below. Accordingly, the specification and figures are to be regarded in an illustrative rather than a restrictive sense and any and all such modifications and other changes are intended to be included within the scope of invention.

Any one or more benefits, one or more other advantages, one or more solutions to one or more problems, or any combination thereof has been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all of the claims.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. Further, references to values stated in ranges include each and every value within that range.

What is claimed is:

1. A film comprising a fluoropolymer, wherein the fluoropolymer comprises a blend of polyvinyl fluoride and a fluoroadditive, wherein the fluoroadditive comprises a fluoropolymer having pendant trifluoromethyl groups.

2. The film of claim 1, wherein the fluoropolymer having pendant trifluoromethyl groups comprises a vinyl fluoride interpolymer, a tetrafluoroethylene-hexafluoropropylene copolymer, a perfluoro vinyl ether, a perfluoroalkyl ethylene, a perfluoroalkoxy polymer, a fluoroelastomer, or a mixture thereof.

3. The film of claim 2, wherein the fluoropolymer having pendant trifluoromethyl groups comprises a vinyl fluoride interpolymer.

4. The film of claim 3, wherein the vinyl fluoride interpolymer comprises an interpolymer consisting essentially of units derived from vinyl fluoride and at least two highly fluorinated monomers.

5. The film of claim 4, wherein at least one of the highly fluorinated monomers introduces into the polymer a side chain of at least one carbon atom.

6. The film of claim 3, wherein the vinyl fluoride interpolymer comprises an interpolymer consisting essentially of units derived from about 20 to about 60 mol % vinyl fluoride, from about 10 to about 60 mol % of at least one C₂ olefin selected from the group consisting of vinylidene fluoride, tetrafluoroethylene, trifluoroethylene, and chlorotrifluoroethylene, and from about 1 to about 20 mol % of a highly fluorinated monomer which introduces into the polymer a side chain of at least one carbon atom.

7. The film of claim 6, wherein the highly fluorinated monomer which introduces into the polymer a side chain of at least one carbon atom is selected from the group consisting of hexafluoropropylene, 1,1-dihydrotetrafluoropropylene, 1,2-dihydrotetrafluoropropylene, perflourobutyl ethylene, and mixtures thereof.

8. The film of claim 6, wherein the interpolymer consists essentially of vinyl fluoride, tetrafluoroethylene and hexafluoropropylene.

9. The film of claim 1, wherein the fluoropolymer comprises from about 0.5 to about 35 weight percent of fluoroadditive based on total weight solids.

10. The film of claim 9, wherein the fluoropolymer comprises from about 1.25 to about 20 weight percent of fluoroadditive based on total weight solids.

11. The film of claim 1, wherein the fluoropolymer has an advancing water contact angle of at least about 90 degrees.

12. The film of claim 1, wherein the fluoropolymer has a receding water contact angle of at least about 60 degrees.

13. The film of claim 1, wherein the fluoropolymer has an advancing hexadecane contact angle of at least about 25 degrees.

14. The film of claim 1, wherein the fluoropolymer has a receding hexadecane contact angle of at least about 15 degrees.

15. A fluoropolymer coated film comprising:
a polymeric substrate film; and
a fluoropolymer coating on the polymeric substrate film, wherein the fluoropolymer coating comprises a blend of polyvinyl fluoride and a fluoroadditive and the fluoroadditive comprises a fluoropolymer having pendant trifluoromethyl groups.

16. The fluoropolymer coated film of claim 15, further comprising a primer, an adhesive, or both a primer and an adhesive.

17. A highly cleanable article comprising a fluoropolymer, wherein the fluoropolymer comprises a blend of polyvinyl fluoride and a fluoroadditive, wherein the fluoroadditive comprises a fluoropolymer having pendant trifluoromethyl groups.

18. The highly cleanable article of claim 17, wherein the highly cleanable article can be cleaned without the use of an organic solvent.

19. The highly cleanable article of claim 17, wherein an image made using a permanent marker can be removed from the highly cleanable article without the use of organic solvents or other liquids.
